(19) United States
(12) Patent Application Publication
(10) Pub. No.: US 2017/0087853 A1
(43) Pub. Date: Mar. 30, 2017

(54) METHOD FOR ACCURATE FAULT DIAGNOSIS IN AN INKJET PRINT HEAD

(71) Applicant: Océ-Technologies B.V., Venlo (NL)

(72) Inventors: Amol A. KHALATE, Venlo (NL); Dhruv KHANDELWAL, Venlo (NL); Siep WEILAND, Venlo (NL)

(73) Assignee: Océ-Technologies B.V., Venlo (NL)

(21) Appl. No.: 15/266,896

(22) Filed: Sep. 15, 2016

(30) Foreign Application Priority Data
Sep. 30, 2015 (EP) 15187679.4
Dec. 9, 2015 (EP) 15198589.2

(51) Int. Cl. B41J 2/165

(52) U.S. Cl. CPC B41J 2/16579; B41J 2/045

(57) ABSTRACT

In a method for identifying of and distinguishing between at least two different predetermined disturbance states in an inkjet print head, the method comprises providing a disturbance identification input signal; applying the disturbance identification input signal to an actuator, the actuator being part of an ejection unit of an inkjet print head; receiving a residual pressure wave output signal; and analyzing the residual pressure wave output signal. The step of analyzing comprises designing and providing a respective mathematical analysis operator for each identifiable disturbance state; executing each respective mathematical analysis operator using the received residual pressure wave output signal as an input for each respective mathematical analysis operator; comparing an output of each respective mathematical analysis operator to a respective predetermined output reference; deciding for each predetermined disturbance state whether the disturbance state is present, wherein it is decided that a corresponding disturbance state is present, if an output of a respective mathematical analysis operator corresponds to the respective predetermined output reference; and it is decided that a corresponding disturbance is not present, if an output of a respective mathematical analysis operator does not correspond to the respective predetermined output reference

### FIELD OF THE INVENTION

The present invention generally pertains to detecting disturbances in a pressure chamber or nozzle of an inkjet print head, in particular a piezo-actuated inkjet print head.

### BACKGROUND ART

It is known to use a piezo-actuator for generating a pressure wave in a pressure chamber of an inkjet print head such that a droplet of liquid, usually ink, is expelled through a nozzle, which nozzle is in fluid communication with the pressure chamber. The combination of a piezo-actuator, a corresponding pressure chamber and the corresponding nozzle may be referred to hereinafter as an inkjet ejection unit. Further, it is known that the piezo-actuator (or an additional piezo-element or a dedicated part of the piezo-actuator) may be used to detect a pressure wave in the pressure chamber. For example, after actuation, a residual pressure wave remains in the pressure chamber and the residual pressure wave may be detected using the piezo-actuator.

For detecting disturbances or ejection faults, it is known that an actuation results in a residual pressure wave, wherein the properties and characteristics of the residual pressure wave are determined by the acoustics in the pressure chamber. So, without any disturbances, a certain residual pressure wave is expected. The detected residual pressure wave may be compared to the expected residual pressure wave for determining whether any disturbances are present. Without such disturbances, it may be presumed that a droplet can be expelled.

If the residual pressure wave deviates from the expected residual pressure wave, it is known to analyze the actual residual pressure wave in order to determine what disturbance is present. For example, an air bubble in the pressure chamber leads to other changes in the acoustics than an obstructing particle in the nozzle. Therefore, based on the actual residual pressure wave and a priori knowledge regarding changes in acoustics and corresponding residual pressure wave properties and characteristics, it may be derived what the actual disturbance is.

Still, differences between residual pressure waves affected by different disturbances may be small and significant uncertainty about the actual disturbance may remain.

In U.S. Pat. No. 7,695,103, it is disclosed to use a sine-wave shaped input signal, wherein the frequency of the sine-wave is selected to be the resonance frequency of a predetermined air bubble. With such a sine-wave shaped input signal, if such an air bubble is present, the resulting residual pressure wave will show the excitation of the resonance frequency and the presence of the air bubble may be derived therefrom. This sine-wave input signal is however only suitable for detecting such an air bubble. If other disturbances are present, these are not detectable, since their response to the sine-wave input signal is most likely different and probably the excited pressure wave is damped as it would be in a well-functioning inkjet ejection unit. As a result, a residual pressure wave similar to the residual pressure wave of a well-functioning inkjet ejection unit is obtained in such a case. Considering that multiple other disturbances, i.e. causes for malfunctioning of the droplet ejection, are known and may occur, only probing for the presence of an air bubble will not prevent that certain inkjet ejection units will malfunction and will negatively affect a resulting print result, such as an image.

In EP2842752 A1 it is disclosed that a drive signal may be adapted to improve a sensed response signal in some respect. For example, it is disclosed that a Signal-to-Noise Ratio (SNR) may be improved. In particular, it is disclosed that the drive signal for jetting and the drive signal for ejector testing may be different. It is however not disclosed how to select an improved drive signal for ejector testing. Moreover, the suggested but not enabled method is directed at affecting a property of a residual pressure wave, while still applying commonly known signal analysis methods to derive an ejector status therefrom.

Considering that different disturbances may require different corrective actions and further considering that incorrect corrective actions may further deteriorate the disturbance, it is desired to have a better method to detect a malfunctioning inkjet ejection unit and to distinguish between at least two different causes (disturbances) of such malfunctioning.

### SUMMARY OF THE INVENTION

In an aspect of the present invention, a method is provided. The method is designed for identifying of and distinguishing between at least two different predetermined disturbance states in an inkjet print head and the method comprises
a) providing a disturbance identification input signal;
b) applying the disturbance identification input signal to an actuator, the actuator being part of an ejection unit of an inkjet print head;
c) receiving a residual pressure wave output signal; and
d) analyzing the residual pressure wave output signal.

In particular, in the method according to the present invention, the step of analyzing comprises:
d1) designing and providing a respective mathematical analysis operator for each predetermined disturbance state;
d2) executing each respective mathematical analysis operator using the received residual pressure wave output signal as an input for each respective analysis operator;
d3) comparing an output of each respective mathematical analysis operator to a respective predetermined output reference;
d4) deciding for each predetermined disturbance state whether the disturbance state is present, wherein it is decided that a corresponding disturbance state is present, if an output of a respective mathematical analysis operator corresponds to the respective predetermined output reference; and it is decided that a corresponding disturbance is not present, if an output of a respective mathematical analysis operator does not correspond to the respective predetermined output reference.

To easily derive the presence of a certain disturbance, a respective mathematical analysis operator may be generated and provided. Each respective mathematical analysis operator is generated such that when the respective mathematical analysis operator is executed with the residual pressure wave output signal as an input, the output of the respective mathematical analysis operator clearly discriminates between the corresponding disturbance being present, or not. For example, the output may be (close to) zero amplitude/value, while the output has a significant amplitude/value if the disturbance is not present. In such an embodiment, a simple threshold may be used as a respective predetermined output reference. In an ideal (e.g. noise free) case, the threshold may be set to zero, but in a practical embodiment, a threshold may be suitably selected between expected values. In a particular embodiment, using a normalization of values, the output of the mathematical analysis operator may have a value between 0 and 1 and the threshold may be selected to be 0.1, for example, if it has been determined that the disturbance not occurring always leads to an output being greater than said 0.1. Any output having an amplitude/value greater than 0.1 is then easily derived as not being disturbed by the corresponding respective disturbance. Having separate analysis for each predetermined potential disturbance provides a positive determination for each predetermined disturbance whether it is present or not. Thus, the analysis is easy and accurate and provides a reliable determination for the presence of each disturbance. Such an analysis is more reliably and better distinguishing between disturbances compared to prior art methods in which a single mathematical procedure is applied and the disturbances are distinguished based on an output of such single mathematical procedure. Moreover, presuming that absence of a disturbance may be considered a disturbance state, it may even be positively determined that no disturbance is present.

For the avoidance of doubt, as used herein, the term ‘mathematical analysis operator’ is intended to encompass any suitable predetermined set of mathematical operations having at least one input and resulting in at least one output. In the present invention, the mathematical analysis operator has at least the resulting residual pressure wave as an input and the mathematical analysis operator has a value as an output. Commonly, such mathematical operators are embodied in software code (wherein the software code is suitable for instructing a computer to perform said predetermined set of mathematical operations), although the mathematical operator may of course as well be embodied in a chip, such as an application specific integrated circuit (ASIC) chip.

In an embodiment of the method according to the present invention, the disturbance identification input signal is specifically designed to generate a residual pressure wave output signal that has a property based on which at least two different disturbance states are readily identifiable and distinguishable in step d.

In the prior art, a droplet ejection is performed after which a residual pressure wave is detected or a detection pulse is used, the detection pulse having a similar pulse shape as a droplet ejection pulse but with a decreased amplitude such that no droplet is actually ejected. In any case, the resulting residual pressure wave output signal is not optimized for deriving a cause of malfunctioning, i.e. a disturbance. According to the present invention, a specific disturbance identification input signal is provided and then applied. The specific disturbance identification input signal is generated to be optimized for discriminating between at least two disturbances (or lack thereof) based on analysis of the resulting residual pressure wave output signal.

In general and in view of the fact that the residual pressure wave is a result of acoustics in a pressure chamber of the ejection unit, a frequency content of the specific disturbance identification input signal may be expected to be significantly different than the frequency content of a droplet ejection pulse. Consequently, such a specific disturbance identification input signal can be presumed to be significantly different in shape than the droplet ejection pulse.

In an embodiment, the disturbance identification input signal is generated based on a difference between a first residual pressure wave output signal reference and a second residual pressure wave output signal reference, each residual pressure wave output signal reference corresponding to a respective disturbance. Taking into account the different acoustics resulting from different disturbances, the disturbance identification input signal may be generated and optimized based on the resulting residual pressure wave output signal. Using commonly available mathematical methodologies, a person skilled in the art is enabled to calculate an optimized disturbance identification input signal, wherein the optimization may relate to timing (e.g. a maximum duration of the input signal), discriminating differences, or any other relevant aspect of the method.

It is noted that the method according to the present invention may be used in an inkjet printer for performing each disturbance analysis, but it may as well be only used for detailed analysis to determine a cause of malfunctioning after the presence of malfunctioning is detected.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1 shows a schematical representation of an embodiment of the present invention;

FIG. 2a-2e show outputs corresponding to the embodiment illustrated in FIG. 1; and

FIG. 3A-3C illustrate a detailed embodiment of the present invention.

### DETAILED DESCRIPTION OF THE DRAWINGS

The present invention will now be described with reference to the accompanying drawings, wherein the same reference numerals have been used to identify the same or similar elements throughout the several views.

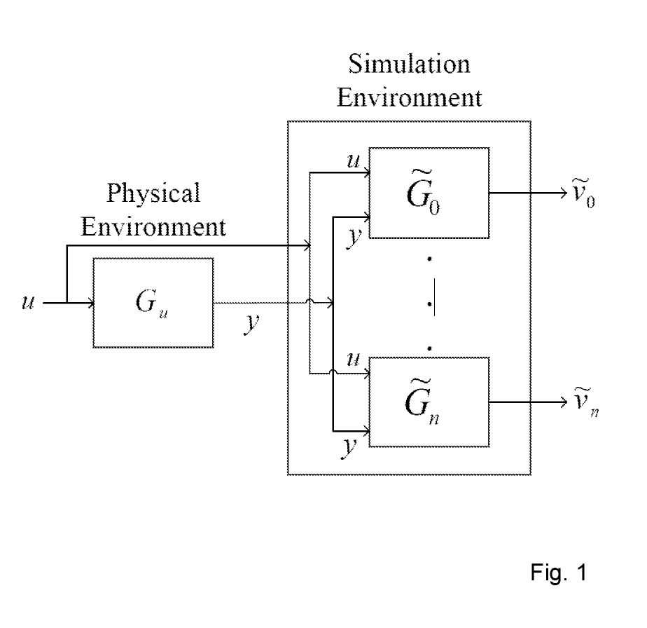

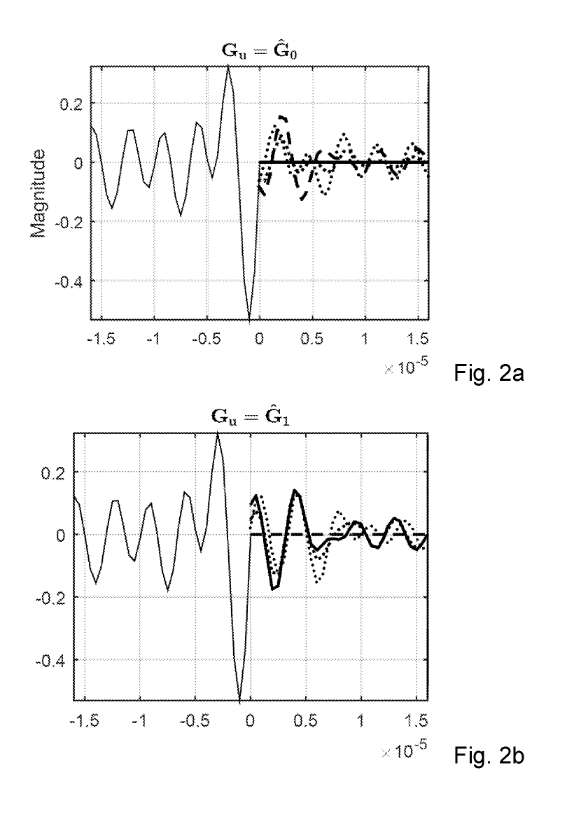

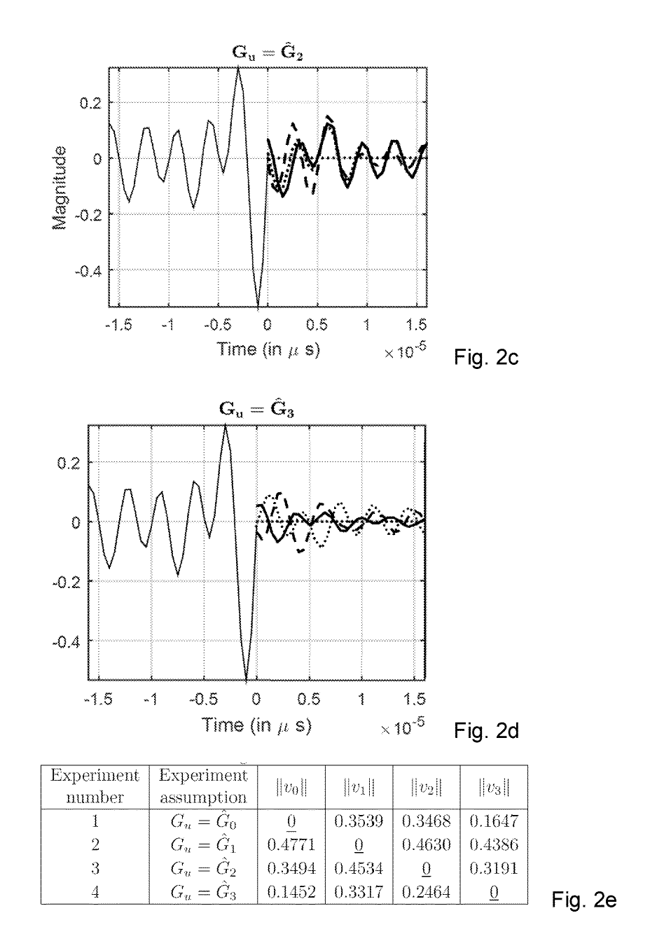

In FIG. 1 an embodiment of the method according to the present invention is shown in a schematical representation, wherein the method is separated in a physical environment and a simulation environment (mathematical analysis operator environment). ‘u’ represents the disturbance identification input signal; ‘Gᵤ’ is a mathematical representation of the physical world, in casu the acoustics in a pressure chamber in an inkjet print head; ‘y’ represents the residual pressure wave output signal. Ĝ₀ represents a respective mathematical analysis operator for disturbance ‘0’ (which might in fact represent that no disturbance is present), while Ĝₙ the respective mathematical analysis operator for disturbance ‘n’. Hence, a number of n+1 analysis operators are present and consequently, in this embodiment, a number of n+1 disturbances may be discriminated between. Each mathematical analysis operator has a corresponding output represented by \hat{v}ₙ. In this embodiment, each respective mathematical analysis operator has the original disturbance identification input signal ‘u’ as an input and the residual pressure wave output signal ‘y’ as an input. Operating on these two inputs, each mathematical analysis operator outputs a corresponding output. These outputs are illustrated in FIG. 2a-2d, wherein n is presumed to be 3. So, four disturbances may be detected. In particular, in the embodiment of FIG. 2a-2e, the disturbance corresponding to Gᵤ=Ĝ₀ is actually the situation wherein no disturbance is present.

In FIG. 2a, the solid curve corresponds to v₀ and is flat, i.e. has an amplitude of zero. The respective mathematical analysis operator has been designed, in combination with the disturbance identification input signal, to render v₀ zero, if no disturbance is present in the corresponding ejection unit. All other outputs from the respective analysis operators have a significant amplitude of the output. Hence, it is readily detected that the respective mathematical analysis operator Ĝ₀ corresponds to the status of the ejection unit. In this case, that means that no disturbance is present.

The graphs in FIGS. 2b-2d illustrate the outputs v₁ (dashed curve), v₂ (dotted curve), v₃ (blocked curve), respectively, being equal to zero, thus showing that a first disturbance corresponding to the respective analysis operator Ĝ₁, a second disturbance corresponding to the respective mathematical analysis operator Ĝ₂ and a third disturbance corresponding to the respective mathematical analysis operator Ĝ₃, respectively, are present.

In the table shown in FIG. 2e, the output signals v₀, v₁, v₂ and v₃ have been mathematically operated on to provide for a single value representing the time-varying signal. As is readily derivable from this table, the zero values are immediately apparent and detectable.

It is noted that the applied specifically designed disturbance identification input signal is shown in FIGS. 2a-2d in the time frame (horizontal axis) from Time=about −1.5 microseconds to Time=0 microseconds.

In more detail, an embodiment of the present invention utilizes transfer models of a nominal disturbance-free system G₀ and a number of models of disturbed systems Gᵢ, wherein i is in a range from 1 to n, n being the number of selected identifiable disturbances.

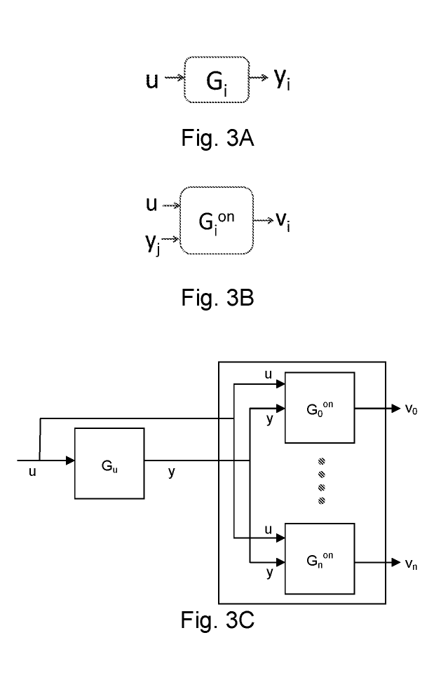

In the diagnosis method, disturbances are described by suitable transfer function models, which are hereinafter referred to as the analysis operators, from the disturbance identification input signal to the residual pressure wave output signal as illustrated in FIG. 3A. Mathematically, this may be represented by

yᵢ=Gᵢ(u) Eq. 1

wherein u is the disturbance identification input signal, Gᵢ is the mathematical analysis operator for disturbance i and yᵢ is the corresponding residual pressure wave output signal. Note that the case wherein i=0 represents the disturbance-free system. Similarly, as used herein, the phrase ‘identifying and distinguishing a disturbance state’ includes the identification and distinguishing of the case wherein a disturbance is actually absent and actually a disturbance free state is the status of the inkjet ejection unit. Then, as illustrated in FIG. 3B, an output-nulling system is designed, wherein the output-nulling system Gᵢ^{on} is designed such that an output vᵢ is zero, if and only if the disturbance identification input signal u and the residual pressure wave output signal yᵢ are applied as inputs, as mathematically represented by:

vᵢ=Gᵢ^{on}(u, yᵢ)=0 Eq. 2a

vᵢ=Gᵢ^{on}(u, yⱼ)#0 Eq. 2b

Having derived such output-nulling systems Gᵢ^{on} for each identifiable disturbance i, a diagnosis system as shown in FIG. 3C (cf. FIG. 1) may be constructed, wherein the transfer function model Gᵤ represents the actual physical system, i.e. the inkjet ejection unit having as an input the disturbance identification input signal u and having as an output the residual pressure wave output signal y. Both the input disturbance identification input signal u and the output residual pressure wave output signal y are then used as inputs for each derived analysis operators Gᵢ^{on} (i=0 . . . n). This results in a number of outputs vᵢ (i=0 . . . n). The output vᵢ that equals zero identifies the disturbance status of the inkjet ejection unit (no disturbance if vₒ=0; disturbance i if vᵢ=0 (i=1 . . . n)). Of course, in practice, the result may be expected to deviate from zero slightly, for example due to noise and minor physical deviations from the ideal situation. So, in practice, the outputs vᵢ may be compared to a predetermined (low) threshold.

For optimal disturbance identification and distinguishing, the disturbance identification input signal u may be optimized such that the residual pressure wave output signals yᵢ together with the output-nulling analysis operators Gᵢ^{on} provide a maximum difference in output value (vᵢ). This is in fact a mathematical optimization problem, which may be solved by known mathematical techniques. In particular, the disturbance identification input signal u may be optimized by maximizing the minimum value vᵢ for each combination of i and j (i=0 . . . n; j=0 . . . n; i#j) in Eq. 2b. Therefore, solving the mathematical problem is not further discussed in detail herein. It is presumed that a person skilled in mathematics is enabled to perform the optimization at least to the extent that different disturbances are identifiable and distinguishable.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for identifying of and distinguishing between at least two predetermined different disturbance states in an inkjet print head, the method comprising:
a) providing a disturbance identification input signal;
b) applying the disturbance identification input signal to an actuator, the actuator being part of an ejection unit of an inkjet print head;
c) receiving a residual pressure wave output signal; and
d) analyzing the residual pressure wave output signal;
wherein the step d) of analyzing comprises:
d1) designing and providing a respective mathematical analysis operator for each predetermined disturbance state;
d2) executing each respective mathematical analysis operator using the received residual pressure wave output signal as an input for each respective mathematical analysis operator;
d3) comparing an output of each respective mathematical analysis operator to a respective predetermined output reference;
d4) deciding for each predetermined disturbance state whether the disturbance state is present, wherein it is decided that a corresponding disturbance state is present, if an output of a respective mathematical analysis operator corresponds to the respective predetermined output reference; and it is decided that a corresponding disturbance is not present, if an output of a respective mathematical analysis operator does not correspond to the respective predetermined output reference.

2. The method according to claim 1, wherein the disturbance identification input signal is specifically designed to generate a residual pressure wave output signal that has a property based on which the at least two disturbance states are readily identifiable and distinguishable in step d.

3. The method according to claim 2, wherein the disturbance identification input signal is generated based on a difference between a first residual pressure wave output signal reference and a second residual pressure wave output signal reference, each residual pressure wave output signal reference corresponding to a respective one of the at least two disturbance states.
